(19) United States
(12) Patent Application Publication
(10) Pub. No.: US 2010/0110212 A1
(43) Pub. Date: May 6, 2010

(54) CAMERA DEVICE

(75) Inventors: Naoki Kuwahara, Tokyo (JP); Koji Sakata, Tokyo (JP); Tetsuji Haga, Tokyo (JP); Koichi Takeuchi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/477,388

(22) Filed: Jun. 3, 2009

(30) Foreign Application Priority Data
Nov. 5, 2008 (JP) 2008-284451

(51) Int. Cl. H04N 5/335; H04N 7/18

(52) U.S. Cl. 348/222.1; 348/148; 348/E05.031; 348/E07.085

(57) ABSTRACT

Setting information is converted into a plurality of image patterns (22), and the plurality of image patterns (22) are displayed in time sequence according to a predetermined sequence. A camera device reproduces the setting information from image information (3) which the camera device acquires by capturing the displayed description to set the setting information thereto.

### BACKGROUND OF THE INVENTION

1. Field of the Invention

The present invention relates to a camera device for use in a camera system, such as a surveillance-oriented CCTV (Closed Circuit TeleVision) system. More particularly, it relates to a camera device which implements a simplified operation of providing setting information.

2. Description of Related Art

Conventionally, in order to simplify an operation of setting image capturing conditions, operating conditions, and so on to a digital camera, there is disclosed a technology of providing recorded image information about an image of a bar code or a two-dimensional image code into which setting information is converted, capturing this image information using the digital camera, and analyzing the image information to set the description recorded in the image information to the digital camera (for example, refer to patent references 1 and 2).

Patent reference 3 describes a camera-equipped mobile phone that sets various pieces of information thereto by capturing recorded image information about an image of a bar code into which setting information is converted using an attached camera in the same way as that mentioned above, and analyzing the image information.

Because the amount of information which can be included in image information about an image pattern is proportional to the complexity of the image pattern, in order to read the image information correctly by using a digital camera, it is necessary to capture a close-up image pattern by bringing the image pickup unit of the digital camera close to the image pattern, and then capturing a close-up shot of the image pattern.
[Patent reference 1] JP, 7-23263,A
[Patent reference 2] JP, 2005-286439,A
[Patent reference 3] JP, 2003-289350,A

A problem with conventional technologies is, however, that because in order to ensure the amount of information included in image information about an image patter the image pattern is made to become complicated, it is impossible to read correctly the image information whose amount of information is large by using a camera unless the camera supports close-up image capturing or unless the display position of the image information to the camera is accurately adjusted.

For example, because a surveillance camera is based on the premise that it captures an area which is the target for surveillance over a wide region of the area, and a lens having a focal length according to this capturing is therefore disposed, close-up image capturing of image information as mentioned above results in a shift of the focus, and therefore the surveillance camera cannot capture the image pattern of the image information clearly and cannot analyze the image information to acquire setting information.

In contrast, when the image information is placed too far away from the image pickup unit of the camera, the image pickup unit of the camera cannot pick up the complicated image pattern because of its insufficient resolution. If the image pattern is a simplified one, although the image pickup unit of the camera can pick up the image pattern even if close-up image capturing of the image pattern is not performed or positioning between the image pattern and the camera is not performed strictly, the amount of information cannot be ensured.

Furthermore, in a case in which the surveillance camera is an IP camera that outputs a captured image to equipment on an IP network, the image which is played back by the equipment does not have desired image quality or the image itself cannot be viewed unless settings about image quality, the network, and so on are not made appropriately. It is therefore necessary to, when installing the surveillance camera, make settings about image quality, the network, and so on according to environmental conditions in the field, system specifications, etc., or change the settings according to environmental conditions in the field.

In the above-mentioned operation, for example, a laptop type PC is connected to the surveillance camera via a LAN cable, and settings are made on the surveillance camera by using a web browser or a dedicated application on the PC. At that time, if the network domain to which the laptop type PC belongs is not the same as that to which the surveillance camera belongs, no settings can be made on the surveillance camera by using the laptop type PC. Therefore, in the conventional system, before any settings are made, the network address of the laptop type PC has to be made to match the network domain of the surveillance camera first.

In a case in which the network domain of the surveillance camera needs to be rechanged because the network domain does not meet field requirements, the laptop type PC has to be connected to the surveillance camera after the network domain and the address of the surveillance camera are changed and the network address of the laptop type PC is then readjusted according to the changed network domain.

Furthermore, because the laptop type PC cannot be connected to the surveillance camera when the network address set to the surveillance camera is unknown, it is necessary to check to see the network address of the surveillance camera or to reset the surveillance camera to the factory settings.

Thus, because an operation of making settings on an IP camera needs equipment for setting, such as a laptop type PC, and also causes an operation, as mentioned above, of connecting the equipment with the camera, other than the setting operation, it takes a great deal of time for an installer who installs the IP camera to perform the setting operation.

### SUMMARY OF THE INVENTION

The present invention is made in order to solve the above-mentioned problems, and it is therefore an object of the present invention to provide a camera device that can ensure the amount of information of setting information and can make information settings easily even if using a simple image pattern by displaying time-varying image patterns so as to define the group of the image patterns displayed in time sequence as image information.

In accordance with the present invention, there is provided a camera device including: a detecting unit for detecting image information which consists of a plurality of image patterns from an image which the camera device acquires by capturing a description which is displayed by a display unit of an information display device including a converting unit for converting setting information into the plurality of image patterns, a forming unit for forming a sequence for displaying in turn the plurality of image patterns to which the setting information is converted by the converting unit, and the display unit for displaying the plurality of image patterns in time sequence on the basis of the sequence; a reproduction unit for reproducing the setting information from the image information detected by the detecting unit; and a setting processing unit for setting the setting information reproduced by the reproduction unit to the camera device.

In accordance with the present invention, the setting information is converted into the plurality of image patterns, the plurality of image patterns are displayed in time sequence according to the predetermined sequence, and the setting information is reproduced from the image information which the camera device acquires by capturing this displayed description to set the setting information to the camera device. Therefore, even if each of the plurality of image patterns is not a complicated one, the amount of information of the setting information included in the image information can be ensured. As a result, even in a case in which the surveillance camera is not suitable for close-up image capturing, the surveillance camera has an advantage of being able to easily set the setting information thereto. Furthermore, because each of the plurality of image patterns can be a simple image pattern, the camera device has an advantage of being able to recognize each of the plurality of image patterns even if the focal point of the lens shifts somewhat, and to support close-up image capturing to a certain extent.

Further objects and advantages of the present invention will be apparent from the following description of the preferred embodiments of the invention as illustrated in the accompanying drawings.

### BRIEF DESCRIPTION OF THE DRAWINGS

FIG. 1 is a view showing schematically a camera system that uses a camera device in accordance with Embodiment 1 of the present invention;

FIG. 2 is a block diagram showing the structure of the camera device in accordance with Embodiment 1;

FIG. 3 is a block diagram showing the structure of an information display device in accordance with Embodiment 1;

FIG. 4 is a view for explaining a process of generating and displaying image information including setting information which is carried out by a mobile terminal shown in FIG. 3;

FIG. 5 is a view showing an example of display of image information;

FIG. 6 is a block diagram showing the structure of a camera device in accordance with Embodiment 2 of the present invention;

FIG. 7 is a view showing schematically a camera system that uses the camera device in accordance with Embodiment 2 of the present invention;

FIG. 8 is a block diagram showing the structure of a camera device in accordance with Embodiment 3 of the present invention; and

FIG. 9 is a view showing schematically a camera system that uses the camera device in accordance with Embodiment 3 of the present invention.

### DETAILED DESCRIPTION OF THE PREFERRED EMBODIMENTS

### Embodiment 1

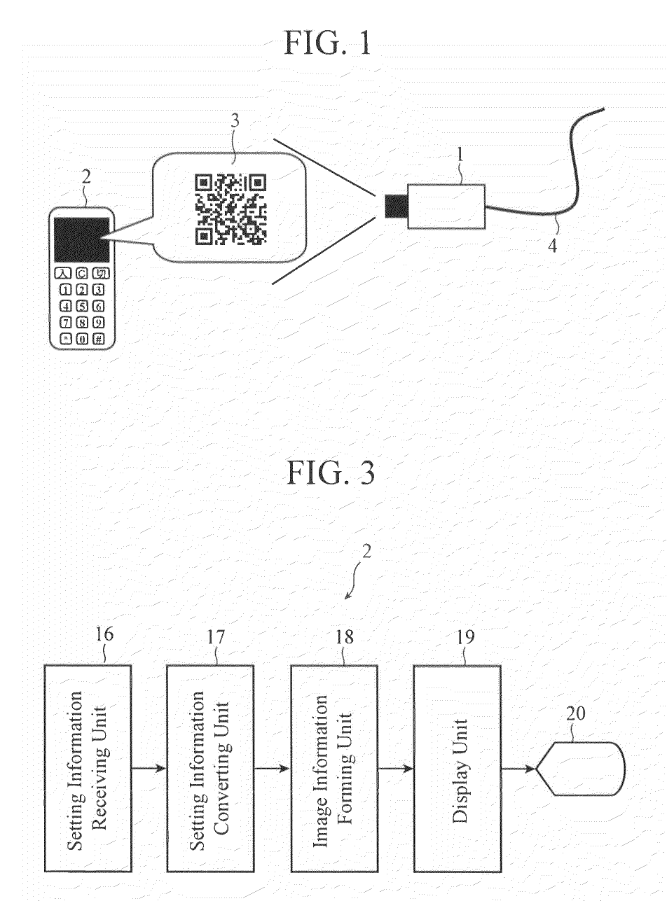

FIG. 1 is a view showing schematically a camera system which uses a camera device in accordance with Embodiment 1 of the present invention, and shows a case in which the camera device in accordance with this embodiment is applied to a surveillance camera system. In FIG. 1, the surveillance camera (the camera device) 1 is an IP (Internet Protocol) camera that can communicate with equipment on a not-shown IP network via a LAN (Local Area Network) cable 4, and performs digital compression coding on a captured image and then outputs the coded image to the equipment on the IP network. In a case in which such an IP camera is installed, it is necessary to set information about image capturing conditions, such as image quality, and the operating conditions of network communications to the camera.

In Embodiment 1, as shown in FIG. 1, the information to be set to the surveillance camera 1 is set to the camera by using image information 3 which is an image pattern (a two-dimensional bar code or the like) to which the information to be set is converted. The surveillance camera 1 uses a lens having a long focal length which is not suitable for close-up image capturing in order to capture an image about a relatively-large area. Therefore, when the image information 3 is brought too close to the surveillance camera 1, the surveillance camera 1 cannot focus on the image information, and therefore cannot read the complicated image pattern.

To solve this problem, in accordance with this Embodiment 1, a relatively-simple image pattern is made to vary at predetermined time intervals and the image information 3 is formed of an image pattern group which consists of a sequence of image patterns which are displayed in time sequence. As a result, the amount of information of the image information 3 can be ensured even though each of the image patterns is a simple one, while even though the camera does not support close-up image capturing, the complicated settings made on the camera can be eliminated.

The relatively-simple image pattern as mentioned above refers to an image pattern which can be recognized even if the focus of the camera lens shifts somewhat, or an image pattern which can be recognized without close-up image capturing even if the image pattern is placed at some distance from the camera. For example, a QR Code (registered trademark; statement showing that the QR Code is a registered trademark will be omitted hereafter) generally needs a monochrome pattern of 21 or more×21 or more cells arranged horizontally and vertically in an array. In accordance with the present invention, simplified 8×8 or 4×4 cells which are arranged horizontally and vertically in an array are used instead.

In a mobile phone (an information display device) 2, software for implementing the function of converting setting information consisting of characters input to the mobile phone into image patterns as mentioned above which are to be displayed in time sequence, and sequentially displaying the above-mentioned image patterns on the screen at predetermined time intervals in response to a user's operation is disposed. A CPU of the mobile phone 2 implements the above-mentioned function by executing this software program.

When the user sets the setting information to the surveillance camera 1 by using the mobile phone 2, the user places the mobile phone 2 at a position where the surveillance camera 1 can capture an image displayed on the screen of the mobile phone first. In this state, the mobile phone 2 executes the above-mentioned software according to the user's operation. The surveillance camera 1 captures, as image information 3, the image pattern group which consists of the above-mentioned image patterns sequentially displayed in time sequence on the screen of the mobile phone.

In a case in which the surveillance camera 1 can capture 30 frames per second, assuming that time-varying image patterns are displayed for every frame, the surveillance camera 1 can read the image information 3 which consists of 30 image patterns within one second. In this case, when each image pattern is an image of 4×4 cells (=16 cells) arranged horizontally and vertically in an array, assuming that one cell shows 1-bit information, 16 bits=2 bytes of information can be contained in a single image pattern, and therefore the image information 3 can consist of data having a maximum of 60 bytes per 1 second.

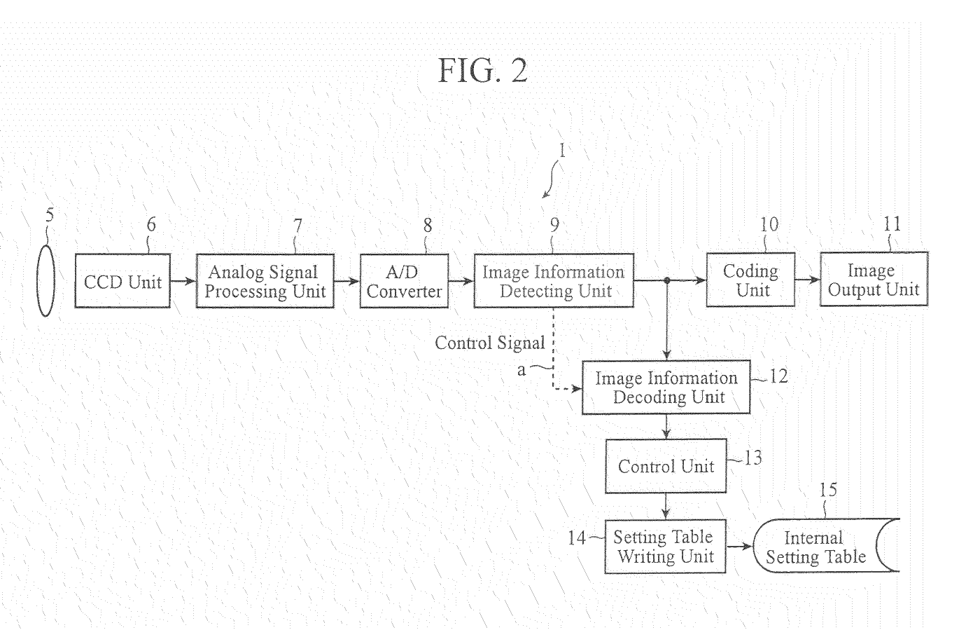

FIG. 2 is a block diagram showing the structure of the camera device in accordance with Embodiment 1, and shows the structure of the surveillance camera shown in FIG. 1. In FIG. 2, the surveillance camera 1 is provided with a lens 5, a CCD unit 6, an analog signal processing unit 7, an A/D converter 8, an image information detecting unit (a detecting unit) 9, a coding unit 10, an image output unit 11, an image information decoding unit (a reproduction unit) 12, a control unit 13, a setting table writing unit (a setting processing unit) 14, and an internal setting table 15. The lens 5 is disposed in an image pickup unit of the surveillance camera 1, and focuses light incident thereupon from an object to be shot. The CCD unit 6 converts the incident light focused by the lens 5 into an image signal.

The analog signal processing unit 7 converts the image signal outputted from the CCD unit 6 into an analog image signal. The A/D converter 8 converts the analog image signal outputted from the analog signal processing unit 7 into a digital image signal. The image information detecting unit 9 is a component that detects the presence or absence of the image information 3 which consists of the image patterns each of which is, for example, a bar code, from the digital image signal to which the analog image signal is converted by the A/D converter 8, and, when detecting the image information 3, controls the image information decoding unit 12 to make this image information decoding unit to decode the image information 3.

The coding unit 10 codes the digital image signal inputted thereto via the image information detecting unit 9. The image output unit 11 outputs the image information coded by the coding unit 10 to outside the surveillance camera 1. For example, the image output unit 11 outputs the image information coded to equipment on the IP network by way of the LAN cable 4. The image information decoding unit 12 extracts the image patterns of the image information 3 detected by the image information detecting unit 9 from the digital image signal according to a control signal a from the image information detecting unit 9, and decodes the image patterns to acquire numerical information or character information.

The control unit 13 identifies the setting information to be set to the surveillance camera 1 from the numerical information or the character information acquired by the image information decoding unit 12, and instructs the setting table writing unit 14 to update the internal setting table 15 by using the identified setting information. The setting table writing unit 14 updates the internal setting table 15 by using the description of the setting information identified by the control unit 13 according to an instruction from the control unit 13. The internal setting table 15 is table data in which various pieces of setting information for defining the operation of the surveillance camera 1, and so on are registered.

FIG. 3 is a block diagram showing the structure of the information display device in accordance with Embodiment 1, and shows components for performing a display process of displaying the image information which are formed in the mobile phone 2 shown in FIG. 1. In FIG. 3, a setting information receiving unit 16 is a component that receives an input of the information to be set to the surveillance camera 1, and provides a GUI (Graphical User Interface) which enables a user to input the setting information by way of the screen of the mobile phone 2. A setting information converting unit (a converting unit) 17 converts the setting information acquired by the setting information receiving unit 16 into image patterns by using a conversion table.

An image information forming unit (a forming unit) 18 complies the plurality of image patterns generated by the setting information converting unit 17 into an image sequence, and also adds an image sequence for start to the head of this image sequence and adds an image sequence for end to the image sequence to generate image information 3. A display unit 19 is a component that performs a process of displaying an image on a display 20, and sequentially displays images on the screen of the display 20 according to the image sequence acquired from the image information forming unit 18. The display 20 is the display unit of the mobile phone 2.

By loading a program of performing setting information processing according to the scope of the present invention into a microcomputer's CPU mounted in the mobile phone 2, and then making the CPU execute the program, the setting information receiving unit 16, the setting information converting unit 17, the image information forming unit 18, and the display unit 19 can be implemented as a concrete means including software and hardware which operate in cooperation with each other on the microcomputer.

Next, the operation of the camera system will be explained.

(1) Process of Generating and Displaying the Image Information including the Setting Information

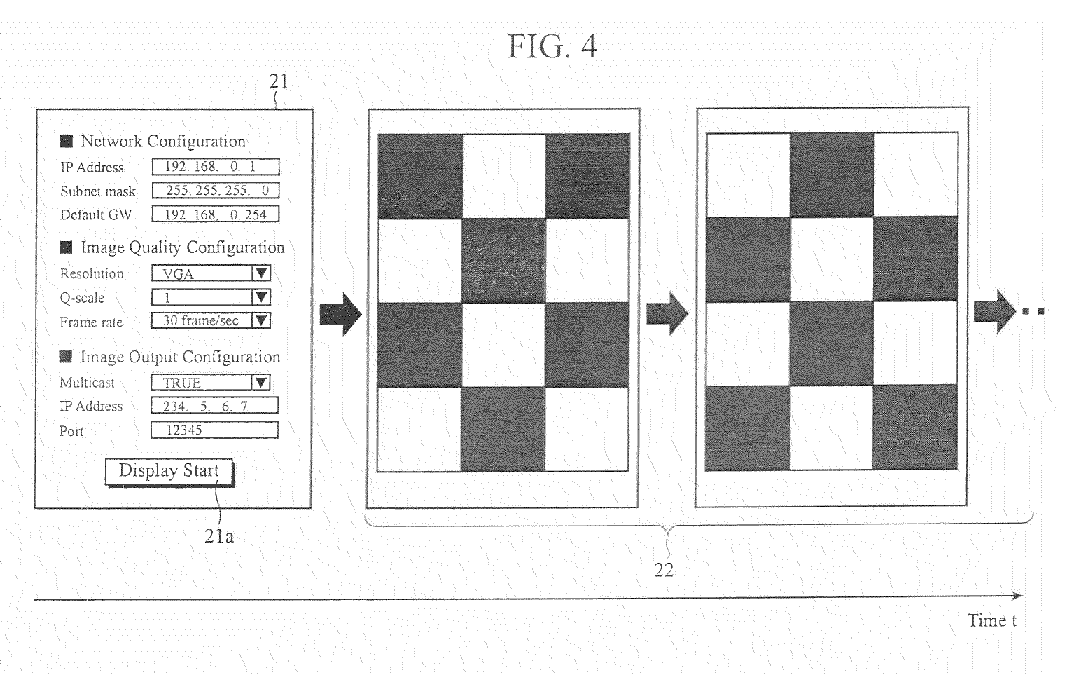

FIG. 4 is a view for explaining the process of generating and displaying the image information including the setting information which is carried out by the mobile terminal shown in FIG. 3, and the details of the process of generating and displaying the image information will be explained with reference to FIGS. 3 and 4. First, the setting information receiving unit 16 of the mobile phone 2 displays an input screen 21 for enabling a user to input information to be set to the surveillance camera 1, and receives an input of the setting information provided by the user.

The example of FIG. 4 shows a screen with which the user sets up conditions of network communications. The user can selectively input each of various setting values by pushing down a corresponding solid filled triangular symbol shown in the screen 21 by using an input unit, such as key buttons of the mobile phone 2. The inputted setting information is stored in a not-shown memory of the mobile phone 2. The setting information receiving unit 16 waits for a pushdown of a display start button 21a shown in the input screen 21, and, when the user completes the input of the setting information and then pushes down the display start button 21a, ends the display of the input screen 21.

Next, the setting information converting unit 17 reads the setting information from the above-mentioned memory, and forms the setting information into images by using the conversion table. As a method of converting the setting information into images, there can be provided a method of dividing the character string of the setting information into individual characters, and then expressing, as an image, the ASCII code of each of the characters in turn.

For example, each screen pattern 22 shown in FIG. 4 is an image pattern in which 12 black or white blocks are horizontally and vertically arranged in an array of 4×3, and the ASCII code of each of the characters is converted into an image assuming that each of the blocks in each screen pattern is 1-bit information showing white or black. While each ASCII code is 8 bits long, each image pattern 22 which is displayed on the screen of the mobile phone 2 has a size of 12 blocks in the example of FIG. 4.

Therefore, image information 3 per one image pattern 22 represents 12 (blocks)/8 (blocks per character)=1.5 (characters). That is, as shown in FIG. 4, when displaying two image patterns 22 in time sequence on the screen of the mobile phone 2, the mobile phone 2 can express three characters. Furthermore, when displaying 100 image patterns 22 in time sequence on the screen of the mobile phone 2, the mobile phone 2 can express 150 characters. Thus, the setting information converting unit 17 converts the read setting information into a plurality of image patterns 22 in turn.

Next, the image information forming unit 18 complies the plurality of image patterns 22 generated by the setting information converting unit 17 into an image sequence, and also adds an image sequence for start and an image sequence for end to the head of the image sequence to construct image information 3. The display unit 19 displays the image information 3 on the screen of the display 20 according to the image sequence inputted thereto from the image information forming unit 18.

The image sequence for start serves as a synchronizing signal for notifying the start of the display of the image information 3 to the surveillance camera 1. As the simplest example of the image sequence for start, a single color image white-colored which consists of a block group including only white blocks and a single color image black-colored which consists of a block group including only black blocks are alternately displayed in a certain blink pattern. The image sequence for end serves as a synchronizing signal for notifying the end of the display of the image information 3 to the surveillance camera 1.

By thus using both the image sequence for start and the image sequence for end which can be set up according to a simple algorithm, a program module which constructs the image information forming unit 18 can be simplified, and can be implemented easily into the mobile phone 2. There is also an advantage of being able to enable the surveillance camera 1 to know the image size of the setting information in advance.

Although the simple method of converting the setting information into images by using ASCII codes is shown in the above-mentioned explanation, in actual fact, information about error resistance, direction information for detecting the direction of the images, or the like is added to the setting information, or the setting information is converted into images by using a complicated conversion table.

(2) Process of Setting Setting Information Using Image Information

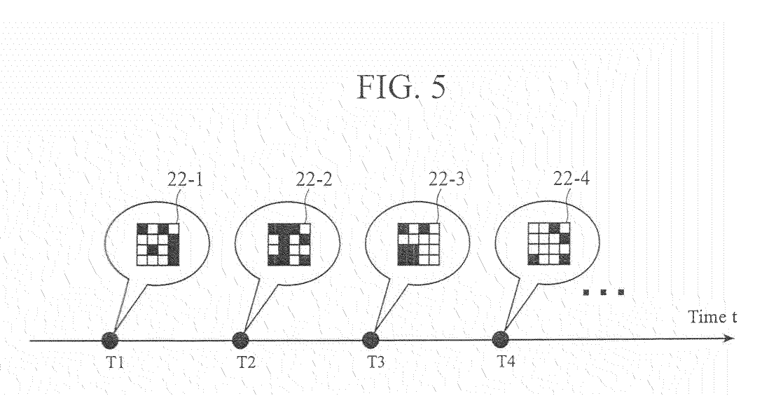

The details of a process of setting setting information to the surveillance camera 1 by using image information will be explained with reference to FIG. 2 and FIG. 5 which will be mentioned later. First, a user places the mobile phone 2 in such a way that the screen of the mobile phone is directed toward the image pickup unit of the surveillance camera 1, and starts the surveillance camera 1 capturing an image and also pushes down the display start button 21a shown in FIG. 4. The surveillance camera 1 captures the description displayed on the screen of the mobile phone 2, and the captured light incident from the object to be shot is focused by the lens 5.

The CCD unit 6 then converts the incident light focused by the lens 5 into an image signal. The analog signal processing unit 7 converts the image signal outputted from the CCD unit 6 into an analog image signal. The A/D converter 8 converts the analog image signal outputted from the analog signal processing unit 7 into a digital image signal.

The image information detecting unit 9 detects the presence or absence of the image information 3 which consists of the above-mentioned image patterns 22 from the digital image signal to which the analog image signal is converted by the A/D converter 8. The image information detecting unit 9 checks to see whether or not the image information 3 is included in every and each frame of the image generated from the digital image signal inputted from the A/D converter 8.

More specifically, the image information detecting unit 9 examines whether the image sequence for start used as the synchronizing signal is included in image frames first. As a method of examining whether the image sequence for start used as the synchronizing signal is included in image frames, the image information detecting unit uses a method of detecting edges of every and each of the image frames and dividing every and each of the image frames into regions. At that time, the image information detecting unit 9 observes a region having a certain size or larger in every and each of several successive images frames so as to check to see whether or not a specific flicker signal which serves as the image sequence for start exists in the region.

When detecting the image sequence for start, the image information detecting unit 9 judges that the image information 3 exists in this region. Although the image information 3 including the setting information exists in this region and its neighboring regions of each and every of subsequent frames, the image information detecting unit 9 performs the detection of edges continuously so as to track this region of each and every of subsequent frames. The image information detecting unit 9 continues the detection of the region including the image information 3 by tracking the region in this way.

FIG. 5 is a view showing an example of the display of the image information, and shows a case in which different image patterns 22-1 to 22-4 each of which is 4×4 cells arranged horizontally and vertically in an array are displayed in the order of times T1, T2, T3, and T4. When the surveillance camera 1 can capture 30 image frames per second, assuming that time-varying image patterns are displayed for every frame, the surveillance camera 1 can read 30 image patterns within one second. In the example shown in FIG. 5, when each image pattern is an image of 4×4 cells (=16 cells) arranged horizontally and vertically in an array, assuming that one cell shows 1-bit information, 16 bits=2 bytes of information can be contained in a single image pattern, and therefore data having a maximum of 60 bytes per 1 second can be included in the image information 3 as the setting information.

Every time when detecting a region including the image information 3 from the digital image signal to which the analog image signal is converted by the A/D converter 8, the image information detecting unit 9 also outputs a control signal a including the region to the image information decoding unit 12. The image information decoding unit 12 decodes the image information 3 included in the region of each image frame which is detected by the image information detecting unit 9 into numerical information or character string information according to the control signal a from the image information detecting unit 9. When detecting the image sequence for end, the image information detecting unit 9 ends the above-mentioned tracking process.

The control unit 13 reads the numerical information or the character string information which is acquired from the region of each image frame by the image information decoding unit 12, and then unifies plural pieces of numerical information or character string information to identify which type of information to be set to the surveillance camera 1 the acquired setting information is. After identifying which type of information to be set to the surveillance camera 1 the acquired setting information is, the control unit 13 instructs the setting table writing unit 14 to update the internal setting table 15 by using the identified setting information.

The setting table writing unit 14 updates the internal setting table 15 by using the description of the setting information identified by the control unit 13 according to an instruction from the control unit 13. As a result, the surveillance camera 1 reads the description registered in the internal setting table 15 as needed when starting operating, and the surveillance camera 1 then operates according to the various pieces of setting information registered in the internal setting table 15.

As mentioned above, the camera system in accordance with this Embodiment 1 converts setting information into a plurality of image patterns 22, displays the plurality of image patterns 22 in time sequence according to a predetermined sequence, and reproduces the setting information from the image information 3 which the camera device acquires by capturing this displayed description to set the setting information to the camera device. Therefore, even if each of the plurality of image patterns 22 is not a complicated one, the amount of information of the setting information included in the image information 3 can be ensured. As a result, even in a case in which the surveillance camera 1 is not suitable for close-up image capturing, the surveillance camera 1 can easily set the setting information thereto. Furthermore, because each of the plurality of image patterns 22 can be a simple image pattern, the surveillance camera can recognize each of the plurality of image patterns even if the focal point of the lens shifts somewhat, and can also support close-up image capturing to a certain extent.

Furthermore, in accordance with this Embodiment 1, when the image information detecting unit 9 detects the image information 3 which consists of the plurality of image patterns which are displayed in time sequence by the display unit 19 of the mobile phone 2, the image information forming unit 18 identifies the start and the end of the setting information on the basis of specific image patterns added to the sequence. By using these specific image patterns this way, the sequence of the image patterns to which the setting information is converted can be simplified and the surveillance camera 1 can know the image size of the setting information in advance.

In above-mentioned Embodiment 1, even in a case in which the surveillance camera 1 is an IP camera as shown in FIG. 1, the need for using any equipment for setting, such as a laptop type PC, is eliminated, and the user is enabled to easily set the setting information to the surveillance camera 1 by simply using the mobile phone 2 which displays the image information 3. Furthermore, even in a case in which a laptop type PC is connected to the surveillance camera 1 via a LAN cable, the setup of a network domain to the laptop type PC can be eliminated if a network domain corresponding to the laptop type PC is set to the surveillance camera 1 by using the mobile phone 2. As a result, there is provided an advantage of reducing the load on an installer who installs the camera device as compared with conventional cases.

In above-mentioned Embodiment 1, the case in which specific image patterns are used as a synchronizing signal indicating the setting start and a synchronizing signal indicating the setting end is shown. Furthermore, some cells of each image pattern can be used for error correction of the image information 3. In addition, because the shutter timing of the surveillance camera 1 is not synchronized with the update timing of the image information 3, the update timing of the image information 3 can be set to one-half or less of the highest frame rate of the surveillance camera 1. For these reasons, there can be a case in which the amount of information included in the image information 3 becomes less than (the number of cells×the frame rate of the camera). However, this does not influence the essence of the present invention.

There is a case in which a minimum number of cells based on a standard, such as 21×21 cells arranged horizontally and vertically in an array, is determined for a two-dimensional bar code like a QR Code, though the present invention is not influenced by any specific standard and does not add any constraints to the cell size of the image information 3.

Furthermore, in above-mentioned Embodiment 1, the case in which a two-dimensional bar code is used as the image information 3 is explained, though it cannot be overemphasized that the image information 3 is not limited to a bar code and can be formed in one of various formats. For example, an image pattern formed in an original format as shown in above-mentioned Embodiment 1 or an image pattern which is a two-dimensional bar code based on another standard can be alternatively used.

In addition, in above-mentioned Embodiment 1, the mobile phone 2 is shown as the information display device which displays the image information 3, though the information display device is not limited to the mobile phone 2 and any device which can display the image information 3, e.g., a mobile PC, a PDA (Personal Digital Assistant), a laptop type PC, an electronic paper, or a projector can be alternatively used as the information display device.

### Embodiment 2

A camera device in accordance with the present Embodiment 1 additionally includes a function of outputting information indicating whether or not an information setting has been made thereon as desired to outside the camera device in addition to the structure of the surveillance camera shown in above-mentioned Embodiment 1.

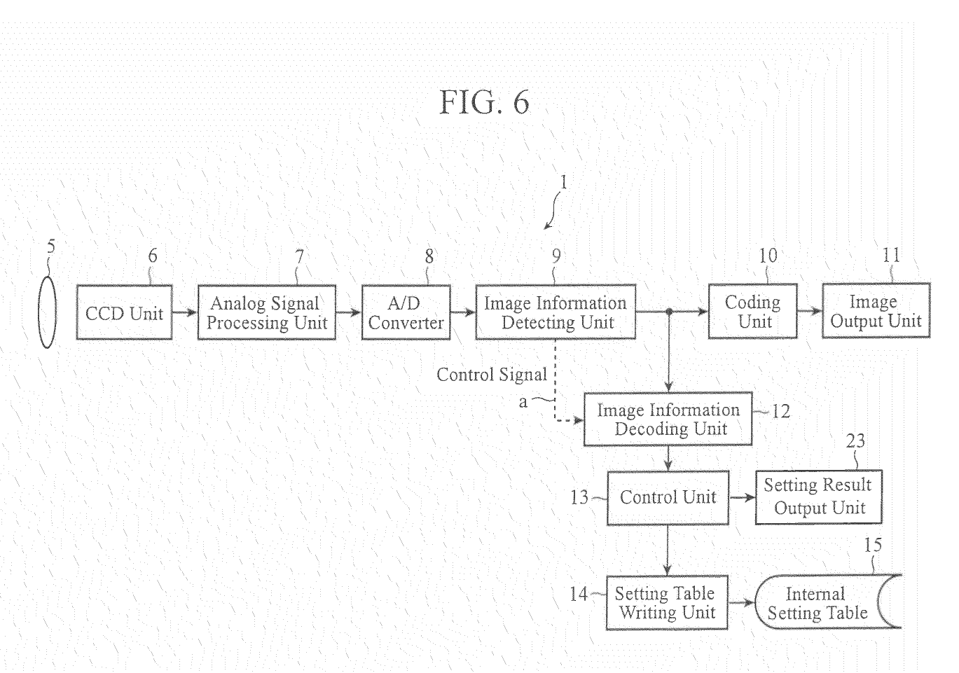

FIG. 6 is a block diagram showing the structure of the camera device in accordance with Embodiment 2 of the present invention. In FIG. 6, the surveillance camera 1A in accordance with Embodiment 2 includes a setting result output unit 23 that outputs the setting results to outside the surveillance camera, in addition to the structure explained in above-mentioned Embodiment 1 with reference to FIG. 2. The setting result output unit 23 generates the body of an email having a description specified by a control unit 13, and also transmits the email to a preset mail server on an IP network according to a mail transfer protocol, such as SMTP (Simple Mail Transfer Protocol). Thereby, the user can check the success or failure of a setup of setting information from the description of the email transferred from the mail server by using a terminal in which a piece of mail software is disposed. In FIG. 6, the same components as those shown in FIG. 2 or like components are designated by the same reference numerals, and the explanation of the components will be omitted hereafter.

Next, the operation of the camera device will be explained.

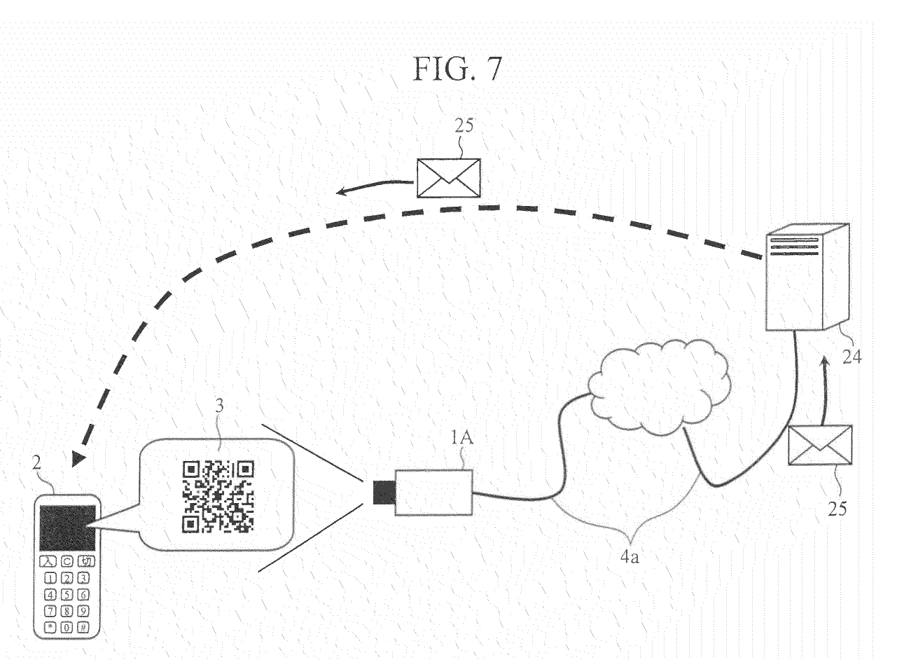

FIG. 7 is a view schematically showing a camera system which uses the camera device in accordance with Embodiment 2, and the details of the operation of the camera system will be explained with reference to FIGS. 6 and 7. Like in the case of above-mentioned Embodiment 1, a user places a mobile phone 2 in such a way that the screen of the mobile phone is directed toward an image pickup unit of the surveillance camera 1A. Next, the user makes the mobile phone 2 display image information 3 which consists of a plurality of image patterns arranged in time sequence on the display thereof, and makes the surveillance camera 1A start capturing the image information 3. After that, the surveillance camera 1 carries out an information setting process in the same way that the surveillance camera in accordance with above-mentioned Embodiment 1 does.

When an image information decoding unit 12 cannot acquire setting information from the image information 3 as a result of decoding the image information 3 or when the image information decoding unit 12 can acquire the setting information from the image information 3, but cannot write the setting information in an internal setting table 15 and therefore the internal setting table 15 cannot be updated, the control unit 13 issues an instruction for transmitting an email showing the failure to the setting result output unit 23. In contrast, when the camera device has succeeded in updating the description of the internal setting table 15, the control unit 13 issues an instruction for transmitting an email showing the success to the setting result output unit 23.

The setting result output unit 23 generates the body of a mail having the description specified by the control unit 13, and transmits an email 25 having the above-mentioned description to the mail server 24 via a LAN cable 4a and a network. The mail server 24 forwards the above-mentioned email 25 to the mobile phone 2. The user can check to see whether the camera device has succeeded in setting the setting information thereto from the description of the email 25 received by the mobile phone 2.

The email 25 can include not only the information indicating whether the camera device has succeeding in setting the setting information thereto, but also the description of the setting information set to the camera device. In this case, the user can check to see whether or not the setting information set to the camera device is the desired one despite the fact that the description of the setting information has been updated. In addition, the camera device enables the user to check the success or failure of the setting from the body of the email 25 including the description of the setting information set to the camera device. As an alternative, when the camera device has failed in setting the setting information thereto, the camera device does not generate the email 25 to enable the user recognize that the setting has ended in failure because the user does not receive the email 25.

As mentioned above, the camera device in accordance with this Embodiment 2 includes the setting result output unit 23 that outputs the success or failure of a setting of setting information thereto to outside the camera device. Because the surveillance camera 1A thus outputs the setting results to outside the surveillance camera, the surveillance camera 1A enables the user to know the success or failure of the setting externally, and therefore, even when the surveillance camera has failed in the setting, the user can make a transition to a resetting procedure promptly without misunderstanding that the surveillance camera has succeeded in the setting.

In above-mentioned Embodiment 2, the case in which the setting results are transmitted to outside the camera device by using the email 25 is explained. For example, the surveillance camera 1A can have a Web server function of transmitting the email 25 to the mobile phone 2.

As an alternative, the surveillance camera 1A can be constructed in such a way as to superimpose the setting information on an image which the surveillance camera outputs onto the network so as to enable equipment on the network to display the image transmitted from the surveillance camera 1A, thereby enabling the user to recognize the setting information visually to check to see whether or not the setting information is the desired one.

Furthermore, in a case in which the surveillance camera 1A is provided with a display unit such as an LED, the surveillance camera 1A can be constructed in such a way as to display the success or failure of the setting with a specific color on this LED. When informing the success or failure of the setting to outside the surveillance camera 1A, the surveillance camera 1A can use various information output forms. For example, the surveillance camera 1 can have an audio output function of notifying the success or failure of the setting of the setting information by voice (e.g., by using a mechanical sound, such as a simple beep sound).

### Embodiment 3

A surveillance camera in accordance with this Embodiment 3 has an operation mode for information setting, and performs a detecting process of detecting image patterns including setting information only in this operation mode for information setting.

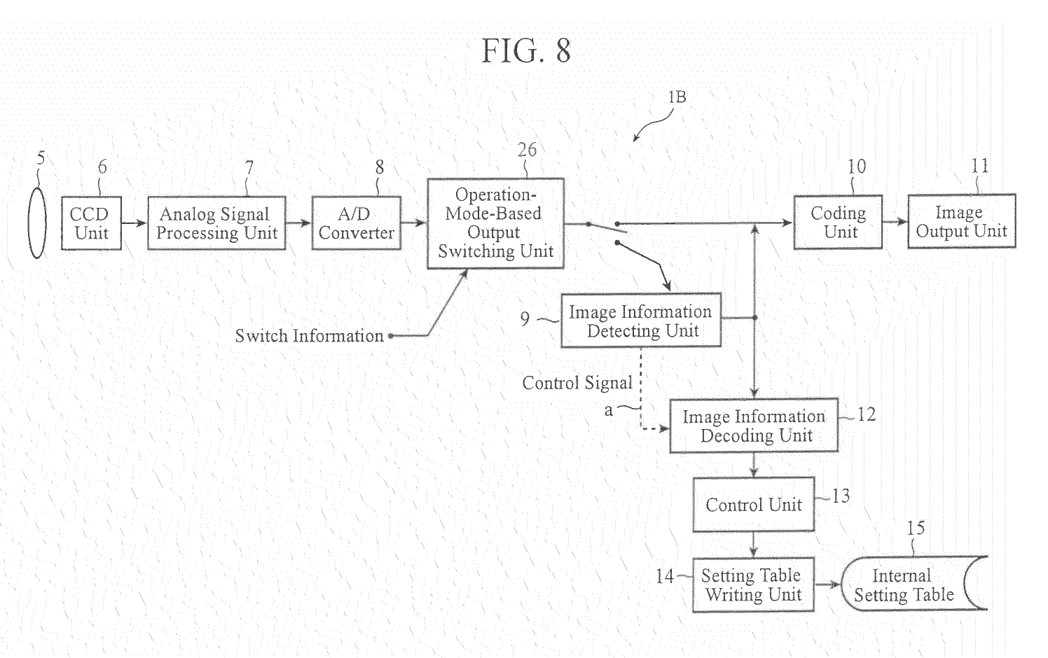

FIG. 8 is a block diagram showing the structure of the camera device in accordance with Embodiment 3 of the present invention. In FIG. 8, the surveillance camera 1B in accordance with Embodiment 3 includes an operation-mode-based output switching unit 26, in addition to the structure explained in above-mentioned Embodiment 1 with reference to FIG. 2. The operation-mode-based output switching unit 26 switches the output destination of a digital image signal inputted thereto from an A/D converter 8 between a path to a coding unit 10 and a path to an image information detecting unit 9 on the basis of switch information for switching between operation modes. In FIG. 8, the same components as those shown in FIG. 2 or like components are designated by the same reference numerals, and the explanation of the components will be omitted hereafter.

Next, the operation of the camera device will be explained.

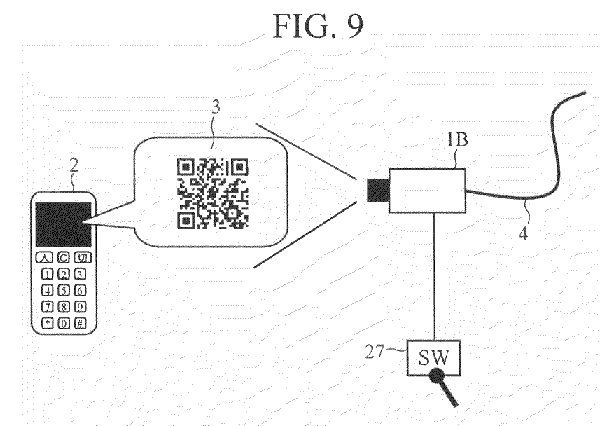

FIG. 9 is a view schematically showing a camera system which uses the camera device in accordance with Embodiment 3, and the details of the operation of the camera system will be explained with reference to FIGS. 8 and 9. Like in the case of above-mentioned Embodiment 1, a user places a mobile phone 2 in such a way that the screen of the mobile phone is directed toward an image pickup unit of the surveillance camera 1B. When the user pushes down an external switch 27 disposed in the surveillance camera 1B, the surveillance camera 1B outputs switch information for switching between operation modes to the operation-mode-based output switching unit 26.

When the inputted switch information shows the information setting mode, the operation-mode-based output switching unit 26 switches the output destination of the digital image signal inputted thereto from the A/D converter 8 to the image information detecting unit 9. In contrast, when the inputted switch information does not show the information setting mode, the operation-mode-based output switching unit 26 switches the output destination of the digital image signal inputted thereto from the A/D converter 8 to the coding unit 10.

As mentioned above, the camera device in accordance with this Embodiment 3 includes the operation-mode-based output switching unit 26 that can switch to the operation mode for information setting, and the image information detecting unit 9 detects image information 3 which consists of a plurality of image patterns to which setting information is converted from an image which the camera device has acquired by capturing a description displayed on the display unit of the mobile phone 2 only in the operation mode for information setting. By doing in this way, the camera device in accordance with this Embodiment 3 can stop the start of components involved in the detection and setting of the image information 3 in an operation mode other than the operation mode for information setting, thereby being able to reduce the processing load on the surveillance camera 1B.

In above-mentioned Embodiment 3, the example in which the switch information is inputted to the camera device from outside the camera device is explained, though the external switch is not necessarily needed to make switching between operation modes in the surveillance camera 1B. For example, during a predetermined time interval (e.g., during 3 minutes) after the surveillance camera 1B is powered on, the operation-mode-based output switching unit 26 is controlled to place the surveillance camera 1B in the operation mode for information setting. By controlling the operation-mode-based output switching unit in this way, the surveillance camera does not need the switch information from outside the camera device. In the present invention, it is important that the surveillance camera has the operation mode for information setting, and how to place the surveillance camera in the operation mode for information setting is not essential to the present invention.

The structures shown in above-mentioned Embodiments 1 to 3 can be combined properly. For example, there can be provided a surveillance camera including, in addition to the structure shown in FIG. 2, either or both of the setting result output unit 23 shown in FIG. 6 and the operation-mode-based output switching unit shown in FIG. 8.

Many widely different embodiments of the present invention may be constructed without departing from the spirit and scope of the present invention. It should be understood that the present invention is not limited to the specific embodiments described in the specification, except as defined in the appended claims.

What is claimed is:

1. A camera device comprising:
a detecting unit for detecting image information which consists of a plurality of image patterns from an image which said camera device acquires by capturing a description which is displayed by a display unit of an information display device including a converting unit for converting setting information into the plurality of image patterns, a forming unit for forming a sequence for displaying in turn the plurality of image patterns to which the setting information is converted by said converting unit, and said display unit for displaying said plurality of image patterns in time sequence on a basis of said sequence;
a reproduction unit for reproducing said setting information from said image information detected by said detecting unit; and
a setting processing unit for setting said setting information reproduced by said reproduction unit to said camera device.

2. The camera device according to claim 1, wherein when detecting the image information which consists of the plurality of image patterns which are displayed in time sequence by the display unit of the information display device, the detecting unit specifies a start and an end of said setting information on a basis of specific image patterns which are added to the sequence by the forming unit of said information display device.

3. The camera device according to claim 1, wherein the camera device has a setting result output unit for outputting information about success or failure in the setting of the setting information to outside said camera device.

4. The camera device according to claim 2, wherein the camera device has a setting result output unit for outputting information about success or failure in the setting of the setting information to outside said camera device.

5. The camera device according to claim 1, wherein the camera device has an operation mode switching unit for switching to an operation mode for information setting, and the detecting unit detects the image information which consists of the plurality of image patterns, to which the setting information is converted, from the image which said camera device acquires by capturing the description which is displayed by the display unit of the information display device only in said operation mode for information setting.

6. The camera device according to claim 2, wherein the camera device has an operation mode switching unit for switching to an operation mode for information setting, and the detecting unit detects the image information which consists of the plurality of image patterns, to which the setting information is converted, from the image which said camera device acquires by capturing the description which is displayed by the display unit of the information display device only in said operation mode for information setting.

7. The camera device according to claim 3, wherein the camera device has an operation mode switching unit for switching to an operation mode for information setting, and the detecting unit detects the image information which consists of the plurality of image patterns, to which the setting information is converted, from the image which said camera device acquires by capturing the description which is displayed by the display unit of the information display device only in said operation mode for information setting.
